(19) United States
(12) Patent Application Publication
(10) Pub. No.: US 2025/0263133 A1
(43) Pub. Date: Aug. 21, 2025

(54) SYSTEM AND METHOD FOR WORK VEHICLE

(71) Applicant: CNH Industrial Brasil Ltda., Nova Lima (BR)

(72) Inventors: Leonardo dos Santos Carvalho, Piracicaba-SP (BR); Joao Augusto Marcolin Lucca, Piracicaba-SP (BR); Ivan Luis Duarte Forti, Piracicaba-SP (BR); Alessandro Roberto Pereira, Piracicaba-SP (BR)

(21) Appl. No.: 19/055,201

(22) Filed: Feb. 17, 2025

(30) Foreign Application Priority Data
Feb. 19, 2024 (BR) 10 2024003137 7

(51) Int. Cl. B62D 33/06

(52) U.S. Cl. CPC B62D 33/0608

(57) ABSTRACT

A suspension system for a work vehicle can include one or more first support brackets configured to operably couple with a base component. One or more respective retainment brackets configured to operably couple with the one or more first support brackets and a cab. The one or more respective retainment brackets is configured to rotate relative to the one or more first support brackets about a pitch axis. One or more second support brackets is configured to operably couple with the base component. A cab crib is operably coupled with the one or more second support brackets. A suspension cylinder is coupled to the cab crib. A locking assembly is at least partially coupled with the cab crib and configured to selectively retain a cab frame.

### FIELD

The present disclosure generally relates to systems and methods for a cab suspension system for a work vehicle, such as sugar cane harvesters.

### BACKGROUND

Several models of work vehicles include a cab that is mounted onto a chassis of the work vehicle. As the vehicle traverses a field or roadway, vibrational and/or impact forces may be imparted from the chassis to the cab, which in turn reduces ride quality and operator comfort. Such forces may cause the cab to jounce, rotate from side to side and/or front to back, or vibrate.

Accordingly, a system and method for a cost-effective and efficient cab suspension system would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a suspension system for a work vehicle that includes one or more first support brackets configured to operably couple with a base component. One or more respective retainment brackets configured to operably couple with the one or more first support brackets and a cab. The one or more respective retainment brackets is configured to rotate relative to the one or more first support brackets about a pitch axis. One or more second support brackets is configured to operably couple with the base component. A cab crib is operably coupled with the one or more second support brackets. A suspension cylinder is coupled to the cab crib. A locking assembly is at least partially coupled with the cab crib and configured to selectively retain a cab frame.

In some aspects, the present subject matter is directed to a method of operating a suspension system of a harvester. The method includes disengaging a locking assembly to release a cab frame from a cab crib. The cab crib operably is coupled with a base component. The method also includes actuating a position actuator to rotate the cab frame from a first position to a second position about a pitch axis.

In some aspects, the present subject matter is directed to a work vehicle that includes a cab frame, a base component, and a suspension system operably coupled with the cab frame and the base component. The suspension system includes one or more first support brackets configured to operably couple with the base component. The suspension system also includes one or more respective retainment brackets configured to operably couple with the one or more first support brackets and a cab. The one or more respective retainment brackets is configured to rotate relative to the one or more first support brackets about a pitch axis. In addition, the suspension system includes one or more second support brackets configured to operably couple with the base component. A cab crib is operably coupled with the one or more second support brackets. A suspension cylinder is coupled to the cab crib. A position actuator is operably coupled with the cab frame and is configured to assist in moving the cab frame from a first position to a second position about the pitch axis.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic side view of a work vehicle for the harvesting of tall and stalky vegetable crops, such as sugarcane and sorghum, in accordance with aspects of the present subject matter;

FIG. 2 illustrates a schematic side view of a portion of an agricultural in accordance with aspects of the present subject matter;

FIG. 3 is a front view of a portion of a work vehicle and a cab suspension system in accordance with aspects of the present subject matter;

FIG. 4 is a side view of a portion of a work vehicle and a cab suspension system with a cab in a first position in accordance with aspects of the present subject matter;

FIG. 5 is a side view of a portion of a work vehicle and a cab suspension system with a cab in a first position in accordance with aspects of the present subject matter;

FIG. 6 is a rear perspective view of the cab suspension system in accordance with aspects of the present subject matter;

FIG. 7 is a front perspective view of the cab suspension system in accordance with aspects of the present subject matter; and

FIG. 8 is a flow diagram of a method of operating a suspension system of a harvester in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with other examples to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product through a system. For example, “upstream” refers to the direction from which an agricultural product moves, and “downstream” refers to the direction to which the agricultural product moves. The term “selectively” refers to a component's ability to operate in various states (e.g., an ON state and an OFF state) based on manual and/or automatic control of the component.

The terms “fore” and “aft” refer to relative positions along the work vehicle relative to a fore-aft axis. The fore direction is a direction along the fore-aft axis that may also be referred to as a forward motion direction of the vehicle. In addition, an aft direction along the fore-aft is a direction along the fore-aft axis that may also be referred to as a rearward motion direction of the vehicle. A lateral direction may be defined by a transverse axis that extends between a right side and a left side of the vehicle and may be perpendicular to the fore-aft axis. As such, any component that is “laterally inward” of another component may be positioned in closer proximity to the fore-aft axis, and any component that is “laterally outward” of another component may be positioned in closer proximity to the fore-aft axis along the transverse axis. A longitudinal direction may be defined as a third direction in a three-dimensional plane that is perpendicular to the fore-aft axis and the transverse axis. For example, the height of the vehicle may be defined in the longitudinal direction.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value or the precision of the methods or apparatus for constructing or manufacturing the components and/or systems. For example, the approximating language may refer to being within a ten percent margin.

Moreover, the technology of the present application will be described in relation to examples. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to suspension systems and methods for a work vehicle. In some instances, the system can include one or more first support brackets configured to operably couple with a base component. One or more respective retainment brackets can be operably coupled with the one or more first support brackets and can be configured to rotate relative to the first support brackets about a pitch axis. One or more second support brackets can be configured to operably couple with the base component. A cab crib can be operably coupled with the one or more second support brackets. A locking assembly can be at least partially coupled with the cab crib and configured to selectively retain the cab.

In various examples, the system may also include a sensor assembly communicatively coupled to a computing system. In general, the sensor assembly may be configured to detect changes in the position of a given location on the cab frame relative to a base component. The data from one or more sensors provided by the sensor assembly may then be transmitted to the computing system to allow the computing system to monitor the position of the cab frame relative to the base component. Based on the monitored position, the computing system may the control the actuation of one or more suspension cylinders (e.g., via controlling the operation of valves operably coupled with each of the one or more suspension cylinders) in a manner that dampens or reduces the overall magnitude of the relative movement between the cab frame and the base component.

In various instances, the cab frame may be allowed to rotate about two or more axes (e.g., pitch rotation and roll rotation) and may be allowed to translate linearly in three directions (e.g., forward-to-aft movement, side-to-side movement, and vertical movement).

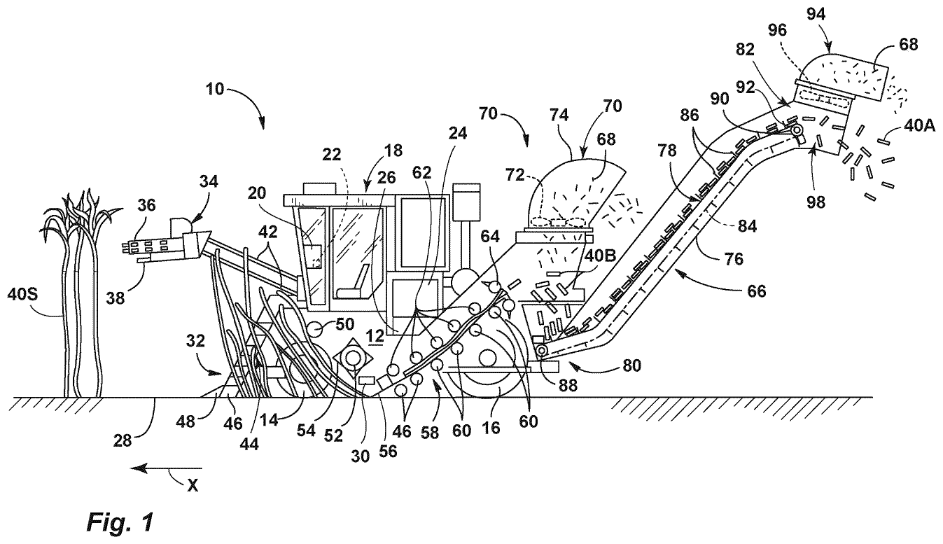

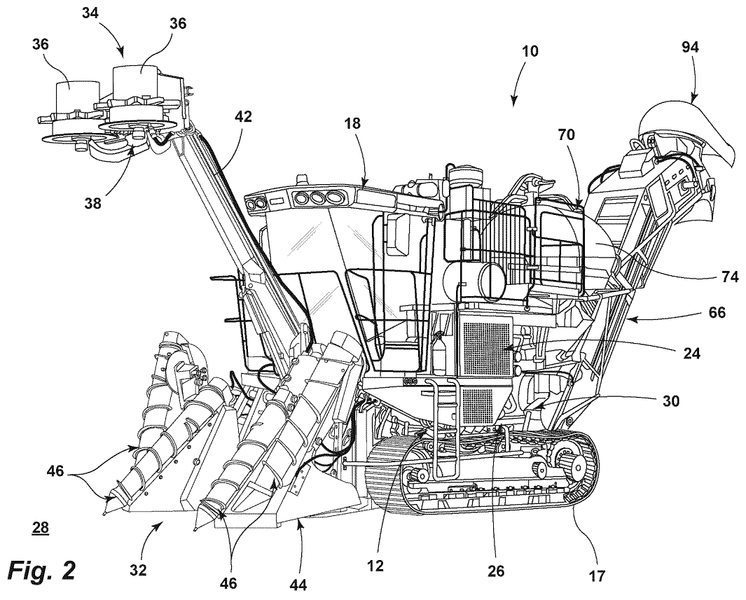

Referring now to the drawings, FIGS. 1 and 2 respectively illustrate a side view of a work vehicle 10 and a side perspective view of a work vehicle 10 in accordance with aspects of the present subject matter. As shown, the vehicle 10 is configured as a sugarcane harvester. However, in other embodiments, the vehicle 10 may be configured as any other suitable agricultural vehicle or any other work vehicle.

As shown in FIGS. 1 and 2, the vehicle 10 can include a chassis 12, a pair of front wheels 14 (FIG. 1), a pair of rear wheels 16 (FIG. 1), and an operator's cab 18 or any other form of operator's station for permitting the operator to control the operation of the vehicle 10. Alternatively, the vehicle 10 may be a track-driven vehicle and, thus, may include a track assembly 17 (FIG. 2) driven by the power source 24 as opposed to the wheels 14, 16 illustrated in FIG. 1. As illustrated in the example shown in FIGS. 1 and 2, the vehicle 10 may include a human-machine interface (HMI) 20 for displaying information (e.g., messages and/or alerts) to the operator and/or for allowing the operator to interface with various systems and components of the vehicle 10.

The HMI 20 may also receive a user input through one or more input devices 22 (e.g., levers, pedals, control panels, buttons, and/or the like) within the cab 18 and/or in any other practicable location. In some cases, the HMI 20 can include a pair of displays, and the information provided on each display may be altered based on various vehicle conditions. The information provided may include operational information that may impact harvesting performance, which may be presented on a clear interface with minimal visual pollution for the operator or another individual. Additionally, or alternatively, the HMI 20 may provide support information that can include a vehicle information, such as vehicle status, vehicle maintenance, and/or the like, that may be intermittently monitored by the operator or another individual.

The vehicle 10 may also include a power source 24 (e.g., an engine mounted on the chassis 12) that powers one or both pairs of the wheels 14, 16 and/or the track assembly 17 via a driveline assembly 26 (e.g., a transmission) to traverse a field 28. The power source 24 may also drive a hydraulic fluid pump 30 configured to generate pressurized hydraulic fluid for a hydraulic circuit, which may be configured to power various components of the vehicle 10, including the driveline assembly 26.

The vehicle 10 may also include a crop processing system 32 incorporating various components, assemblies, and/or sub-assemblies of the vehicle 10 for cutting, processing, cleaning, and discharging sugarcane as the cane is harvested from an agricultural field 28. For instance, the crop processing system 32 may include a topper assembly 34 positioned at the front end portion of the vehicle 10 to intercept sugarcane as the vehicle 10 is moved in a forward direction. As shown, the topper assembly 34 may include both a gathering disk 36 and a cutting disk 38. The gathering disk 36 may be configured to gather the sugarcane stalks 40S so that the cutting disk 38 may be used to cut off the top of each stalk 40S. As is generally understood, the height of the topper assembly 34 may be adjustable via a pair of arms 42, which may be raised and lowered (e.g., hydraulically).

The crop processing system 32 may further include a crop divider 44 that extends upwardly and rearwardly from the field 28. In general, the crop divider 44 may include one or more spiral feed rollers 46. Each feed roller 40 may include a ground shoe 48 at its lower end portion to assist the crop divider 44 in gathering the sugarcane stalks 40S for harvesting. Moreover, as shown in FIGS. 1 and 2, the crop processing system 32 may include a knock-down roller 50 positioned near the front wheels 14 and a fin roller 52 positioned behind the knock-down roller 50. As the knock-down roller 50 is rotated, the sugarcane stalks 40S being harvested are knocked down while the crop divider 44 gathers the stalks 40S from agricultural field 28. Further, as shown in FIGS. 1 and 2, the fin roller 52 may include a plurality of intermittently mounted fins 54 that assist in forcing the sugarcane stalks 40S downwardly. As the fin roller 52 is rotated during the harvest, the sugarcane stalks 40S that have been knocked down by the knock-down roller 50 are separated and further knocked down by the fin roller 52 as the vehicle 10 continues to be moved in the forward direction relative to the field 28.

Referring still to FIGS. 1 and 2, the crop processing system 32 of the vehicle 10 may also include a base cutter assembly 56 positioned behind the fin roller 52. The base cutter assembly 56 may include blades for severing the sugarcane stalks 40S as the cane is being harvested. Additionally, in several embodiments, the blades may be angled downwardly to sever the base of the sugarcane as the cane is knocked down by the fin roller 52.

Moreover, the crop processing system 32 may include a feed roller assembly 58 located downstream of the base cutter assembly 56 for moving the severed stalks 40S of sugarcane from base cutter assembly 56 along the processing path of the crop processing system 32. As shown in FIGS. 1 and 2, the feed roller assembly 58 may include a plurality of bottom rollers 60 and a plurality of opposed top rollers 62. The various bottom and top rollers 60, 62 may be used to pinch the harvested sugarcane during transport. As the sugarcane is transported through the feed roller assembly 58, debris 68 (e.g., rocks, dirt, and/or the like) may be allowed to fall through bottom rollers 60 onto the field 28.

In addition, the crop processing system 32 may include a chopper assembly 64 located at the downstream end section of the feed roller assembly 58 (e.g., adjacent to the rearward-most bottom roller 60 and the rearward-most top roller 62). In general, the chopper assembly 64 may be used to cut or chop the severed sugarcane stalks 40S into pieces or “billets” 40B, which may be, for example, six (6) inches long. The billets 40B may then be propelled towards an elevator assembly 66 of the crop processing system 32 for delivery to an external receiver or storage device.

The pieces of debris 68 (e.g., dust, dirt, leaves, etc.) separated from the sugarcane billets 40B may be expelled from the vehicle 10 through a primary extractor 70 of the crop processing system 32, which may be located downstream of the chopper assembly 64 and may be oriented to direct the debris 68 outwardly from the vehicle 10. Additionally, an extractor fan 72 may be mounted within an extractor housing 74 of the primary extractor 70 for generating a suction force or vacuum sufficient to force the debris 68 through the primary extractor 70. The separated or cleaned billets 40B, which may be heavier than the debris 68 expelled through the extractor 70, may then fall downward to the elevator assembly 66.

As shown in FIGS. 1 and 2, the elevator assembly 66 may include an elevator housing 76 and an elevator 78 extending within the elevator housing 76 between a lower, proximal end portion 80 and an upper, distal end portion 82. In some examples, the elevator 78 may include a looped chain 84 and a plurality of flights or paddles 86 attached to and spaced on the chain 84. The paddles 86 may be configured to hold the sugarcane billets 40B on the elevator 78 as the sugarcane billets 40B are elevated along a top span of the elevator 78 defined between its proximal and distal end portions 80, 82. Additionally, the elevator 78 may include lower and upper sprockets 88, 90 positioned at its proximal and distal end portions 80, 82, respectively. As shown in FIGS. 1 and 2, an elevator motor 92 may be coupled to one of the sprockets (e.g., the upper sprocket 90) for driving the chain 84, thereby allowing the chain 84 and the paddles 86 to travel in a loop between the proximal and distal end portions 80, 82 of the elevator 78.

Moreover, in some embodiments, pieces of debris 68 (e.g., dust, dirt, leaves, etc.) separated from the elevated sugarcane billets 40B may be expelled from the vehicle 10 through a secondary extractor 94 of the crop processing system 32 coupled to the rear end portion of the elevator housing 76. For example, the debris 68 expelled by the secondary extractor 94 may be debris 68 remaining after the billets 40B are cleaned and debris 68 expelled by the primary extractor 70. As shown in FIGS. 1 and 2, the secondary extractor 94 may be located adjacent to the distal end portion 82 of the elevator 78 and may be oriented to direct the debris 68 outwardly from the vehicle 10. Additionally, an extractor fan 96 may be mounted at the base of the secondary extractor 94 to generate a suction force or vacuum sufficient to force the debris 68 through the secondary extractor 94. The separated, cleaned billets 40B, heavier than the debris 68 expelled through the primary extractor 70, may then fall from the distal end portion 82 of the elevator 78. In some instances, the billets 40B may fall through an elevator discharge opening 98 defined by the elevator assembly 66 into an external storage device, such as a sugarcane billet cart.

During operation, the vehicle 10 traverses the agricultural field 28 for harvesting sugarcane. After the height of the topper assembly 34 is adjusted via the arms 42, the gathering disk 36 on the topper assembly 34 may function to gather the sugarcane stalks 40S as the vehicle 10 proceeds across the field 28, while the cutting disk 38 severs the leafy tops of the sugarcane stalks 40S for disposal along either side of the vehicle 10. As the stalks 40S enter the crop divider 44, the ground shoes 48 may set the operating width to determine the quantity of sugarcane entering the throat of the vehicle 10. The spiral feed rollers 46 then gather the stalks 40S into the throat to allow the knock-down roller 50 to bend the stalks 40S downwardly in conjunction with the action of the fin roller 52. Once the stalks 40S are angled downward, as shown in FIGS. 1 and 2, the base cutter assembly 56 may then sever the base of the stalks 40S from the field 28. The severed stalks 40S are then, by the movement of the vehicle 10, directed to the feed roller assembly 58.

The severed sugarcane stalks 40S are conveyed rearwardly by the bottom and top rollers 60, 62, which compresses the stalks 40S, makes them more uniform, and shakes loose debris 68 to pass through the bottom rollers 60 to the field 28. At the downstream end portion of the feed roller assembly 58, the chopper assembly 64 cuts or chops the compressed sugarcane stalks 40S into pieces or billets 40B (e.g., 6-inch cane sections). The processed crop discharged from the chopper assembly 64 is then directed as a stream of billets 40B and debris 68 into the primary extractor 70. The airborne debris 68 (e.g., dust, dirt, leaves, etc.) separated from the billets 40B is then extracted through the primary extractor 70 using suction created by the extractor fan 72. The separated/cleaned billets 40B then be directed to an elevator hopper into the elevator assembly 66 and travel upwardly via the elevator 78 from its proximal end portion 80 to its distal end portion 82. During normal operation, once the billets 40B reach the distal end portion 82 of the elevator 78, the billets 40B fall through the elevator discharge opening 98 to an external storage device. If provided, the secondary extractor 94 (with the aid of the extractor fan 96) blows out trash/debris 68 from the vehicle 10, similar to the primary extractor 70.

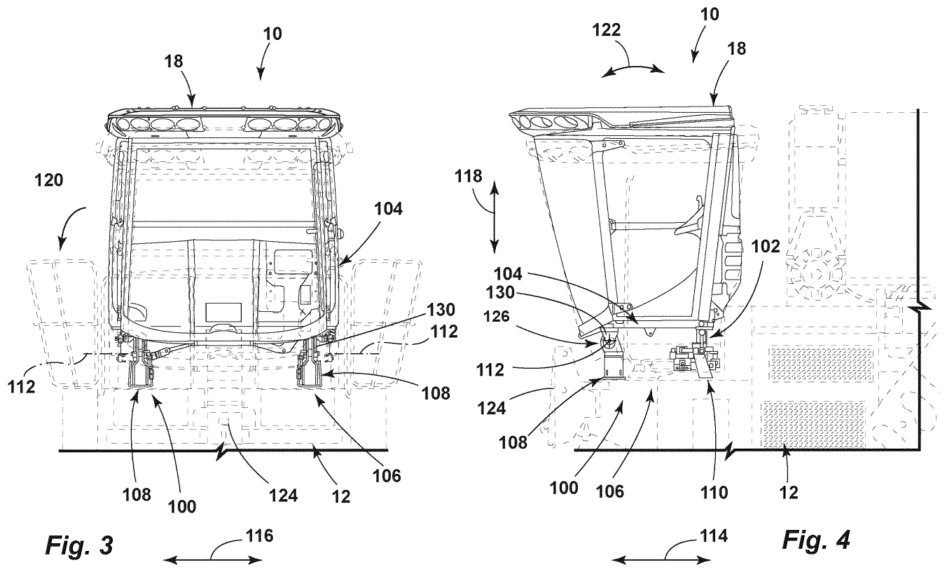

Referring now to FIGS. 3-5, a front view of a cab of the work vehicle 10, a side view of the cab 18 of the work vehicle 10 in a first position, and a side view of the cab 18 of the work vehicle 10 in a second position are respectively illustrated. As shown, a suspension system 100 may include a cab crib 102 operably coupled with the chassis 12. In various instances, the suspension system 100 may be generally designed to allow movement of a cab frame 104 relative to the chassis 12 or other base component 106 to which it is suspended. For instance, the cab frame 104 may be allowed to rotate about two or more axes (e.g., pitch rotation and roll rotation) and may be allowed to translate linearly in three directions (e.g., forward-to-aft movement, side-to-side movement, and vertical movement). It will be appreciated that the base component 106 may generally correspond to any suitable frame, block, and/or other component of the work vehicle 10 (including any combination of such components) above which the cab frame 104 is configured to be suspended. For instance, in some examples, the base component 106 may correspond to the transmission block encasing the various components of the vehicle's transmission. In other examples, the base component 106 may correspond to a frame(s) and/or any other structural member(s) forming all or part of the vehicle's chassis 12.

In several examples, the cab frame 104 may have any suitable configuration that allows it to function as the structural frame for the operator's cab 18. Thus, in several embodiments, the cab frame 104 may include a plurality of structural members configured to be coupled together to form the structural frame. However, the cab frame 104 may have any other suitable frame-like configuration including any combination of structural members.

As shown in FIGS. 3-5, the suspension system 100 may include a first set of brackets 108 and/or a second set of brackets 110 each configured to extend vertically between portions of the cab frame 104 and the base component 106. For example, the suspension system 100 can include a pair of front brackets 108 configured to be coupled between the base component 106 and a front portion of the cab frame 104. In some instances, each of the first support brackets 108 may be coupled to the cab frame 104 via a pinned or pivotal connection to allow the cab frame 104 to rotate relative to the first support brackets 108 about a pitch axis 112.

The second support brackets 110 can be coupled between the base component 106 and the opposed, rear portions of the cab frame 104. As shown in FIGS. 3-5, the second support brackets 110 may be coupled to the cab frame 104 via the cab crib 102 to permit the cab frame 104 to move relative to the brackets 110 as the position and/or orientation of the cab frame 104 relative to the base component 106 is varied.

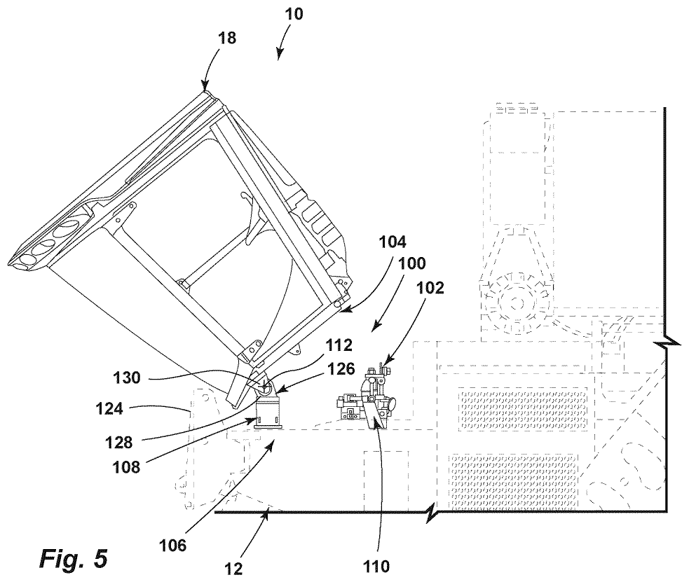

In several embodiments, the connections provided between the cab frame 104 and the front and second support brackets 108, 110 may allow for small lateral movements of the cab frame 104 relative to the support brackets 108, 110, such as small longitudinal (fore-to-aft) movements (indicated by arrow 114 in FIG. 3), small latitudinal (side-to-side) movements (indicated by arrow 116 in FIG. 3) and/or vertical movements (indicated by arrow 118 in FIG. 4). In addition, the connections provided between the cab frame 104 and the front and second support brackets 108, 110 may allow for rotation of the cab frame 104 relative to the brackets 108, 110, such as pitch rotation (indicated by arrow 120 in FIG. 3) about the pitch axis 112 and roll rotation (indicated by arrow 122 in FIG. 4) about an axis.

In some instances, a feature of the vehicle 10, such as a topper support bracket 124, may be positioned forwardly of the cab 18. In such instances, the amount of rotation between the first position, as shown in FIG. 4, and the second portion, as shown in FIG. 5, may be determined based on the spacing between the cab 18 and the feature. To assist in rotating the cab 18, each of the first support brackets 108 can include a rotation assembly 126, which may be in the form of a bearing assembly 128. In such instances, respective retainment brackets 130 may be operably coupled with the cab frame 104 and the bearing assembly 128 so that the respective retainment brackets 130 are rotated relative to the first support brackets 108 about the pitch axis 112.

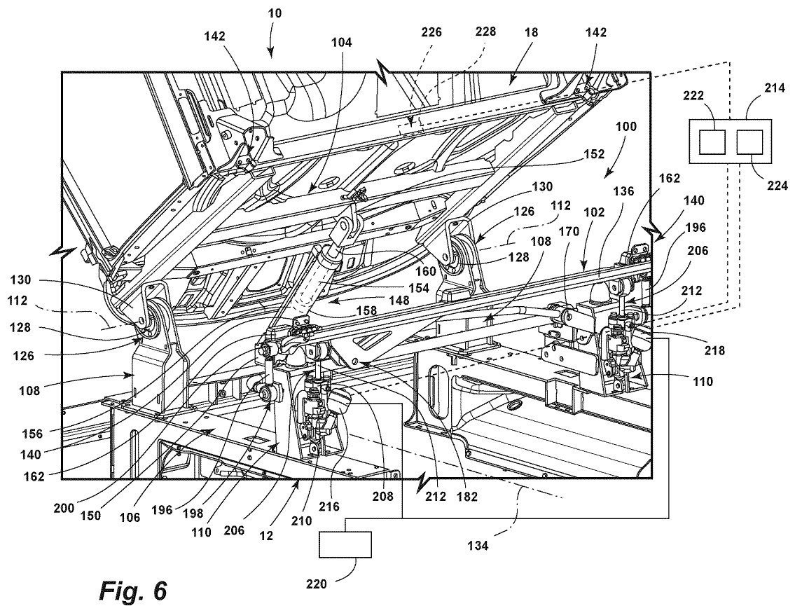

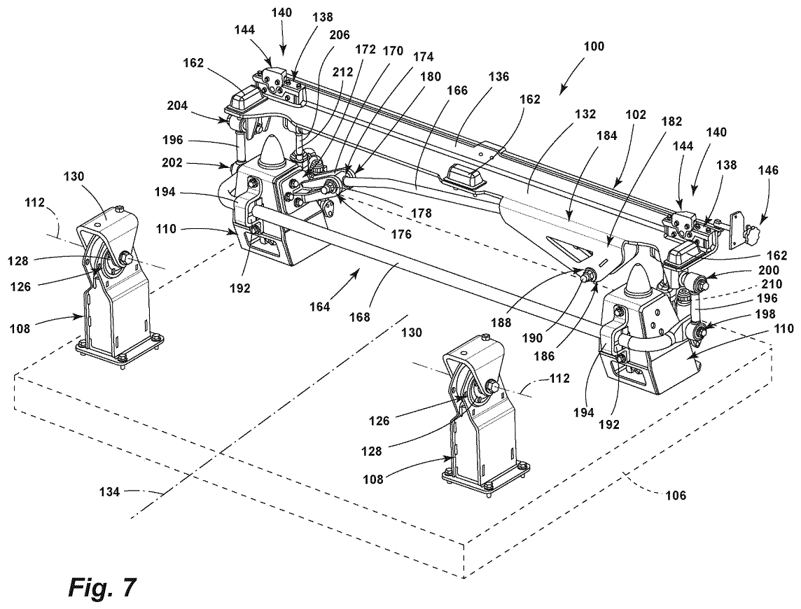

Referring now to FIGS. 6 and 7, the cab crib 102 may also be operably coupled with each of the second support brackets 110. In some instances, the cab crib 102 can include a first section 132 that extends latitudinally relative to a longitudinal axis 134 and a second section 136 that is offset from the first section 132. In some examples, the second section 136 may extend from a first side of the first section 132 and one or more components of the suspension system 100 may be operably coupled with a second, opposing side of the first section 132.

The cab crib 102 can further include one or more attachment structures 138. In some cases, the attachment structure 138 may be coupled to the first section 132 and/or the second section 136. However, the attachment structures 138 may be integrally formed with the cab crib 102 without departing from the teachings provided herein. In several instances, one or more locking assemblies 140 can selectively retain and release the cab frame 104 relative to the cab crib 102. When released, the cab 18 may be rotated relative to the first support brackets 108 about a pitch axis 112. In some cases, the lock assembly can include a first component, which may be in the form of a locking pin 142, operably coupled with the cab 18. The lock assembly can also include a second component, which may be in the form of a latch assembly 144, operably coupled with the cab crib 102. As illustrated, the locking assembly 140 can include a pair of first components operably coupled with the cab 18 and positioned on opposing sides of a longitudinal centerline of the vehicle 10 and a pair of second components operably coupled with the cab crib 102. It will be appreciated that the locking assembly 140 can include any number of first components and second components without departing from the teachings provided herein. Moreover, it will be appreciated that the first component may be operably coupled with the cab 18 and/or the cab crib 102 and the second component may be oppositely operably coupled with the cab crib 102 without departing from the scope of the present disclosure.

In various examples, the locking assembly 140 may further include a release assembly. The release assembly may be configured to release each of the first components and/or any of the first components from the respective second components. When the locking assembly 140 includes more than one respective first component and the second component, the release assembly may independently release each first component through the actuation of the latch assembly 144. Additionally or alternatively, when the locking assembly 140 includes more than one respective first component and the second component, the release assembly may contemporaneously release each first component through the actuation of the latch assembly 144. In various examples, the release assembly may be manually and/or electronically actuated.

In some examples, the suspension system 100 may further include a position actuator 148 that is configured to rotate the cab frame 104 between at least a first position and a second position. The position actuator 148 can be operably coupled with a base structure 150 that may be operably coupled with the base component 106 and/or any other structure and a cab attachment assembly 152, which may be operably coupled with and/or integrally formed with the cab 18. In some examples, the position actuator 148 may be in the form of a position cylinder 154. As shown in FIG. 6, the position cylinder 154 may generally include a cylinder housing 156 and a piston 158 disposed within the housing 156. In addition, the position cylinder 154 may include a rod 160 extending from the piston 158 to a location exterior of the housing 156. As illustrated in FIG. 6, an actuating end portion of the rod 160 may be coupled to the cab frame 104.

Referring further to FIGS. 6 and 7, the suspension system 100 may further include one or more bumpers 162, which may be operably coupled with the cab frame 104, the base component 106, and or any other component of the vehicle 10. The bumpers 162 may be configured to mitigate vibration or contact forces generated between the cab frame 104 and the base component 106, whether during the movement of the cab 18 relative to the base component 106 and/or during the operation of the vehicle 10.

In some instances, the suspension system 100 can further include one or more suspension linkages 164, such as a Panhard bar 166 and an anti-roll bar 168. The suspension linkage 164 may be operably connected to the cab 18 and the base component 106. In general, the suspension linkage 164 may be configured to limit a rotation of the cab 18 about the longitudinal axis 134 of the vehicle 10.

In some cases, a first Panhard bracket 170 may be operably coupled with one (or more) of the second support brackets 110. For instance, in the example illustrated in FIGS. 6 and 7, the first Panhard bracket 170 may be cantilevered from a second support bracket 110 and/or otherwise extend laterally inward from the second support bracket 110. In such instances, a first end portion 172 of the first Panhard bracket 170 may be operably coupled with the second support bracket 110, such as through one or more fasteners. A second end portion 174 of the first Panhard bracket 170 may define a first channel 176. A bolt 178, or other fastener, may be positioned through the first channel 176 and operably support a first portion of the Panhard bar 166. A second Panhard bracket 182 may be operably coupled with the cab crib 102. For instance, in the example illustrated in FIGS. 6 and 7, the second Panhard bracket 182 may extend from the cab crib 102. In such instances, a first portion 184 of the second Panhard bracket 182 may be operably coupled with the cab crib 102, such as through one or more fasteners. A second portion 186 of the second Panhard bracket 182 may define a second channel 188. A bolt 190, or other fastener, may be positioned through the second channel 188 and operably support a second portion of the Panhard bar 166.

Additionally or alternatively, the suspension linkage 164 may include an anti-roll bar 168. The anti-roll bar 168 may extend latitudinally outward of the one or more second support brackets 110. In some cases, the anti-roll bar 168 may be configured in the form of a U-shaped bar. However, the anti-roll bar 168 may have any desired shape. As illustrated, the anti-roll bar 168 can be operably coupled with a pair of bushings 192 and bushing retention brackets 194. The bushings 192 may surround the anti-roll bar 168 at two separate locations such that one bushing 192 is located on one side of the longitudinal axis 134 of the chassis 12 and the other bushing 192 is located on the other side of the longitudinal axis 134 of the chassis 12. The bushings 192 may be in the form of any desired bushings. The bushing retention brackets 194 may at least partially surround and retain the bushings 192. The bushing retention brackets 194 serve to connect the anti-roll bar 168 to the second support brackets 110. As illustrated, each bushing retention bracket 194 can have a U-shape with opposing leg portions coupled with one of the second support brackets 110.

As illustrated, opposing end portions of the anti-roll bar 168 may be respectively coupled with a link 196. In some cases, each of the links 196 may be rotatably coupled with the anti-roll bar 168 proximate to a first end portion of the link 196. Moreover, each of the links 196 may be rotatably coupled with the cab crib 102 proximate to a second end portion of the link 196. For instance, a first link 196 may be operably coupled with a first end portion 198 of the anti-roll bar 168 and a first segment 200 of the cab crib 102 and a second link 196 may be operably coupled with a second end portion 202 of the anti-roll and a second segment 204 of the cab crib 102. In some instances, the first segment of the cab crib 102 and the second segment of the cab crib 102 may be positioned on opposing sides of a longitudinal axis 134.

With further reference to FIGS. 5-7, one or more suspension cylinders 206 may be operably coupled between the cab frame 104 and the base component 106. In various examples, each suspension cylinder 206 may generally include a cylinder housing 208 and a piston 210 disposed within the housing 208. In addition, each cylinder 206 may include a rod 212 extending from the piston 210 to a location exterior of the cylinder housing 208. As shown in FIG. 6, an actuating end portion of the rod 212 may be coupled to the cab crib 102.

With further reference to FIGS. 6 and 7, the suspension cylinders 206 may generally be configured to dampen and/or reduce the movement of the cab frame 104 relative to the base component 106 during operation of the work vehicle 10. In several embodiments, the actuation of the suspension cylinders 206 may be configured to be actively controlled to regulate the movement of the cab frame 104 relative to the base component 106. For example, as shown in FIG. 6, the suspension system 100 may include a computing system 214 communicatively coupled to suitable valves 216, 218 (e.g., suitable pressurize regulating valves, such as solenoid-activated valves) configured to regulate the pressure of hydraulic fluid supplied to each suspension cylinder 206 (e.g., from a hydraulic fluid tank 220 of the work vehicle 10. In some cases, the first and second valves 216, 218 may be provided in fluid communication with each suspension cylinder 206. In such examples, the computing system 214 may be configured to independently regulate the actuation of each suspension cylinder 206 by controlling the operation of its associated valves 216, 218. For instance, a current command supplied to each valve 216, 218 from the computing system 214 may be directly proportional to the pressure supplied to each suspension cylinder 206, thereby allowing the computing system 214 to control the displacement of the suspension cylinder 206.

In general, the computing system 214 may correspond to any suitable processor-based device, such as a computing device or any suitable combination of computing devices. Thus, in several examples, the computing system 214 may include one or more processor(s) 222 and associated memory device(s) 224 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 224 of the computing system 214 may generally comprise memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 224 may generally be configured to store suitable computer-readable instructions that, when implemented by the processor(s) 222, configure the computing system 214 to perform various computer-implemented functions, such as any methods and/or other automated functions described herein. In addition, the computing system 214 may also include various other suitable components, such as a communications circuit or module, one or more input/output channels, a data/control bus, and/or the like.

It will be appreciated that the computing system 214 may correspond to an existing controller of the work vehicle 10 or the computing system 214 may correspond to a separate processing device. For instance, in several examples, the computing system 214 may form all or part of a separate plug-in module that may be installed within the work vehicle 10 to allow for the disclosed suspension system 100 to be implemented without requiring additional software to be uploaded onto existing control devices of the vehicle 10.

Referring particularly to FIGS. 6 and 7, the suspension system 100 may also include a sensor assembly 226 communicatively coupled to the computing system 214. In general, the sensor assembly 226 may be configured to detect changes in the position of a given location on the cab frame 104 relative to the base component 106. The data from the one or more sensors provided by the sensor assembly 226 may then be transmitted to the computing system 214 to allow the computing system 214 to monitor the position of the cab frame 104 relative to the base component 106. Based on the monitored position, the computing system 214 may the control the actuation of the suspension cylinders 206 (e.g., via controlling the operation of the valves 216, 218) in a manner that dampens or reduces the overall magnitude of the relative movement between the cab frame 104 and the base component 106.

In several examples, the sensor assembly 226 may include a sensor 228 mounted to a portion of the cab frame 104. For instance, as shown in FIG. 6, the sensor 228 may be mounted at the aft end portion of the cab frame 104. It should be appreciated that the sensor 228 may generally correspond to any suitable sensor and/or sensing device configured to detect the motion of the cab frame 104 moves relative to the base component 106. For instance, in some cases, the sensor 228 may correspond to an inertial measurement unit (IMU) that measures a specific force, angular rate, and/or an orientation of the cab frame 104 using a combination of accelerometers, gyroscopes, magnetometers, and/or any other practicable device. The accelerometer may correspond to one or more multi-axis accelerometers (e.g., one or more two-axis or three-axis accelerometers) such that the accelerometer may be configured to monitor the movement of the cab 18 in multiple directions, such as by sensing the cab acceleration along three different axes. It will be appreciated, however, that the accelerometer may generally correspond to any suitable type of accelerometer without departing from the teachings provided herein.

In some cases, the data provided by the sensor may be used to confirm that the cab 18 is in the retained position relative to the cab crib 102. For instance, an initial, retained position may be determined by the computing system 214 based on the data from the sensor. If the operation of the vehicle 10 is initiated with the cab 18 offset from the initial position, as determined by the computing system 214 based on the data from the sensor (and/or any other input, such as the cylinders), instructions may be provided to a vehicle notification system (e.g., including components configured to provide visual, auditory, or haptic feedback, such as lights, speakers vibratory components, and/or the like) and/or a remote electronic device.

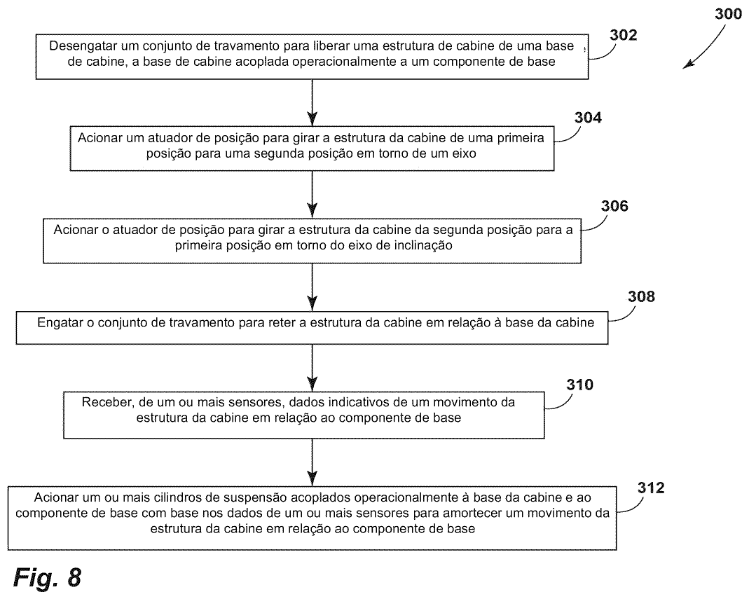

Referring now to FIG. 8, a method 300 of operating a suspension system of a harvester is illustrated in accordance with aspects of the present subject matter. In general, the method 300 will be described herein with reference to the vehicle 10 described above with reference to FIGS. 1-7. However, the disclosed method 300 may generally be utilized with any suitable harvesting assembly. In addition, although FIG. 8 depicts steps performed in a particular order for purposes of illustration and discussion, the methods discussed herein are not limited to any particular order or arrangement. One skilled in the art, using the disclosure provided herein, will appreciate that various steps of the methods disclosed herein can be omitted, rearranged, combined, and/or adapted in various ways without deviating from the scope of the present disclosure.

As shown in FIG. 8, at (302), the method 300 can include disengaging a locking assembly to release a cab frame from a cab crib. As provided herein a suspension system may be positioned between the cab crib and the chassis. In various instances, the suspension system may be generally designed to allow movement of a cab frame relative to the chassis or other base component to which it is suspended. For instance, the cab frame may be allowed to rotate about two or more axes (e.g., pitch rotation and roll rotation) and may be allowed to translate linearly in three directions (e.g., forward-to-aft movement, side-to-side movement, and vertical movement). It will be appreciated that the base component 106 may generally correspond to any suitable frame, block, and/or other component of the work vehicle (including any combination of such components) above which the cab frame is configured to be suspended.

Moreover, the locking assembly can selectively retain and release the cab frame relative to the cab crib. When released, the cab frame may be rotated relative to the first support brackets about a pitch axis. In some cases, the lock assembly can include a first component, which may be in the form of a locking pin, operably coupled with the cab frame. The lock assembly can also include a second component, which may be in the form of a latch assembly, operably coupled with the cab crib.

At (304), the method 300 can include actuating a position actuator to rotate the cab frame from a first position to a second position about a pitch axis. In some instances, the position actuator can configured to rotate the cab frame between at least a first position and a second position.

At (306), the method 300 can include actuating the position actuator to rotate the cab frame from the second position to the first position about the pitch axis. At (308), the method 300 can include engaging the locking assembly to retain the cab frame relative to the cab crib.

At (310), the method 300 can include receiving data indicative of the motion of the cab frame relative to the base component from one or more sensors. In general, the sensor assembly may be configured to detect changes in the position of a given location on the cab frame relative to the base component. The data from the one or more sensors provided by the sensor assembly may then be transmitted to a computing system to allow the computing system to monitor the position of the cab frame relative to the base component.

At (312), the method 300 can include actuating one or more suspension cylinders operably coupled with the cab crib and the base component based on the data from the one or more sensors to dampen the movement of the cab frame relative to the base component.

In various examples, the method 300 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update a cab frame position model. In some instances, the machine learning engine may allow for changes to the cab frame position model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A suspension system for a work vehicle, the suspension system comprising:
one or more first support brackets configured to operably couple with a base component;
one or more respective retainment brackets configured to operably couple with the one or more first support brackets and a cab, the one or more respective retainment brackets configured to rotate relative to the one or more first support brackets about a pitch axis;
one or more second support brackets configured to operably couple with the base component;
a cab crib operably coupled with the one or more second support brackets;
a suspension cylinder coupled to the cab crib; and
a locking assembly at least partially coupled with the cab crib and configured to selectively retain a cab frame.

2. The suspension system of claim 1, further comprising:
an anti-roll bar extending latitudinally outward of the one or more second support brackets and operably coupled with each of the one or more second support brackets through respective bushings.

3. The suspension system of claim 2, further comprising:
one or more bushing retention brackets at least partially surrounding each respective bushing, wherein each respective bushing retention bracket is coupled with one of the one or more second support brackets.

4. The suspension system of claim 2, further comprising:
a first link operably coupled with a first end portion of the anti-roll bar and a first segment of the cab crib; and
a second link operably coupled with a second end portion of the anti-roll bar and a second segment of the cab crib, wherein the first segment of the cab crib and the second segment of the cab crib are positioned on opposing sides of a longitudinal axis.

5. The suspension system of claim 1, further comprising:
a Panhard bar operably coupled with one of the one or more second support brackets and the cab crib on opposing end portions.

6. The suspension system of claim 1, further comprising:
a first Panhard bracket operably coupled with one of the one or more second support brackets, wherein the first Panhard bracket is cantilevered from one of the one or more second support brackets; and
a second Panhard bracket operably coupled with the cab crib.

7. The suspension system of claim 1, wherein the locking assembly includes a latch assembly operably coupled with the cab crib that is configured to interact with a locking pin operably coupled with the cab frame.

8. The suspension system of claim 7, wherein the locking assembly includes a release assembly that releases the locking pin from the latch assembly.

9. The suspension system of claim 1, further comprising:
a sensor operably coupled with the cab frame and configured to detect a change in a position of the cab frame.

10. The suspension system of claim 9, further comprising:
a computing system communicatively coupled to the sensor, the computing system being configured to control an actuation of the suspension cylinder based on data received from the sensor.

11. The suspension system of claim 10, further comprising:
a valve provided in fluid communication with the suspension cylinder, the computing system being configured to control operation of the valve to regulate a supply of fluid to the suspension cylinder.

12. A method of operating a suspension system of a harvester, the method comprising:
disengaging a locking assembly to release a cab frame from a cab crib, the cab crib operably coupled with a base component; and
actuating a position actuator to rotate the cab frame from a first position to a second position about a pitch axis.

13. The method of claim 12, further comprising:
actuating the position actuator to rotate the cab frame from the second position to the first position about the pitch axis; and
engaging the locking assembly to retain the cab frame relative to the cab crib.

14. The method of claim 12, further comprising:
receiving, from one or more sensors, data indicative of a motion of the cab frame relative to the base component.

15. The method of claim 14, further comprising:
actuating one or more suspension cylinders operably coupled with the cab crib and the base component based on the data from the one or more sensors to dampen a movement of the cab frame relative to the base component.

16. A work vehicle comprising:
a cab frame;
a base component; and
a suspension system operably coupled with the cab frame and the base component, the suspension system comprising:
one or more first support brackets configured to operably couple with the base component;
one or more respective retainment brackets configured to operably couple with the one or more first support brackets and a cab, the one or more respective retainment brackets configured to rotate relative to the one or more first support brackets about a pitch axis;
one or more second support brackets configured to operably couple with the base component;
a cab crib operably coupled with the one or more second support brackets;
a suspension cylinder coupled to the cab crib; and
a position actuator operably coupled with the cab frame and configured to assist in moving the cab frame from a first position to a second position about the pitch axis.

17. The work vehicle of claim 16, further comprising:
a locking assembly at least partially coupled with the cab crib and configured to selectively retain the cab frame.

18. The work vehicle of claim 17, wherein the position actuator is configured as a hydraulic cylinder.

19. The work vehicle of claim 16, further comprising:
a sensor operably coupled with the cab frame and configured to detect a change in a position of the cab frame relative to the cab crib.

20. The work vehicle of claim 19, further comprising:
a computing system communicatively coupled to the sensor, the computing system being configured to control an actuation of the suspension cylinder based on data from the sensor.
